(19) United States
(12) Patent Application Publication
(10) Pub. No.: US 2011/0051313 A1
(43) Pub. Date: Mar. 3, 2011

(54) MAGNETICALLY ENHANCED CAPACITANCE FOR HIGH PERFORMANCE THIN FILM CAPACITORS

(76) Inventor: Wein-Kuen HWANG, Hsinchu Industrial Park (TW)

(21) Appl. No.: 12/552,804

(22) Filed: Sep. 2, 2009

(51) Int. Cl. H01G 4/06

(52) U.S. Cl. 361/311

(57) ABSTRACT

A capacitor is disclosed. The capacitor includes a magnetic layer, a first dielectric layer, a second dielectric layer, a first conductive layer and a second conductive layer. The magnetic layer is capable of generating a magnetic field, and is disposed between the first dielectric layer and the second dielectric layer. The first conductive layer is disposed below the first dielectric layer, and second conductive layer is disposed above the second dielectric layer, wherein both the first and the second conductive layer are non-magnetic.

### BACKGROUND

1. Field of Invention

The present invention relates generally to the field of capacitors. More particularly, the present invention relates to magnetically enhanced capacitors.

2. Description of Related Art

Capacitors are reliable sources of power in many applications, such as integrated circuits (IC), printed circuit boards (PCB), and other electronic devices. Capacitors can be fabricated in various shapes and size and provide comparable characteristics to other common power supply devices.

Generally, capacitors essentially consist of two parallel plates and a dielectric material disposed therebetween, as shown in FIG. 1. The capacitor 100 includes two conducting parallel plates 110, 120, and a dielectric material 130. In general, the thickness d of the dielectric material 130 equals the distance between the two conducting plates. The capacitance C of the capacitor 100 can be expressed by equation (1).

C=e₀eᵣA/d (1)

where e₀ is the dielectric constant of free space (8.85×10⁻¹⁴ F/cm), and eᵣ is the relative dielectric constant of the dielectric material disposed between the conducting plates. The product of e₀ and eᵣ is defined as permittivity e, which represents the absolute permittivity of the dielectric material.

According to equation (1), the capacitance of a capacitor increases as the thickness d of the dielectric material decreases. However, the breakdown voltage of the capacitor decreases significantly as the thickness of the dielectric material decreases. Moreover, as the thickness of the dielectric material is reduced to less than about 10 nm, it presents serious challenges to the manufacturing process. Therefore, researchers consider the thickness of the dielectric material as a trade-off among capacitance, breakdown voltage, and productivity.

Another factor that affects the capacitance of a capacitor is the dielectric constant (K) of the dielectric material. The dielectric constant (K) of a material is the ratio of the permittivity over the dielectric constant of free space. A higher K-value implies that more electrical charge/energy could be stored in the capacitors, and a smaller size of the electronic devices can be implemented. Unfortunately, the K-value of conventional dielectric materials, such as mica, glass, plastics, and metal oxides only ranges from 2 to 10 approximately.

Recently, some perovskite-oxides with high K-value have been reported. For instance, the ferroelectric and paraelectric dielectric materials with perovskite-oxide structure have a K-value of about 10³-10⁴. While the dielectric material having a K-value of about 10⁴ and a thickness of about 100 nm is adopted for constructing a capacitor, the corresponding capacitance is about 10⁻⁴ F/cm². Some perovskite metal oxides, such as barium strontium titanate (BST) family, lead zirconium titanate (PZT) family, calcium copper titanate (CCTO) family, exhibit a satisfactory K-value of about 10³ to 10⁶ (See U.S. Pat. No. 7,428,137 and US Patent Publication No. 2008/0218940). As the K-value and thickness of the dielectric material are respectively about 10⁶ and 100 nm, the corresponding capacitance is in the range of 10⁻²-10⁻³ F/cm², and the breakdown voltage is approximately in the range of 10-100 V. It is desirable to implement high-K materials into capacitors for applications in high-energy storage, memory devices (such as MRAM) having high-capacity data storage, or others. Capacitance in the range of 10⁻² to 10⁻³ F/cm² is not enough for high-energy storage applications.

The dielectric constant (K) of La₁₋ₓSrₓMnO₃ is enhanced for about 10² to 10³ folds under an external magnetic filed of 20 KOe (JEPT Letter (2007), 86(10): 643-646). However, it is impractical to provide a magnetic field of 20 KOe for capacitors in electronic devices, an equipment that may generate a magnetic field of over 20 KOe would weigh about 100 Kg. Therefore, there exists in this art a need of a probable way to achieve an effective K value that is greater than 10⁶.

### SUMMARY

The present disclosure provides capacitor having magnetically enhanced capacitance. The capacitor includes a magnetic layer, a first dielectric layer, a second dielectric layer, a first conductive layer and a second conductive layer. The magnetic layer has a magnetization and is capable of generating a magnetic field. The first dielectric layer is disposed below the magnetic layer, while the second dielectric layer is disposed above the magnetic layer. The first conductive layer is disposed below the first dielectric layer, while the second conductive layer is disposed above the second dielectric layer, wherein both the first and the second conductive layer are non-magnetic.

According to one embodiment of the present disclosure, the magnetization of the magnetic layer has a direction that is parallel with or orthogonal to the magnetic layer. Alternatively, the magnetization may have a direction that is at an angle to the magnetic layer.

In the event when the direction of magnetization is parallel with the magnetic layer, the magnetic layer may comprise a material having a formula of Ndₓ(Fe_{y}Co_{1-y})₁₋ₓ, wherein x is a number from about 0.10 to about 0.35, and y is a number from 0 to 1. In another embodiment, the magnetic layer may comprise a material having a formula of (NiᵥCo_{w}Cr_{1-v-w})_{1-x-y-z}PtₓTa_{y}B_{z}, wherein v, w, x, y and z are numbers that satisfy the following inequalities: 0≦v<0.2, 0.75<(v+w)≦1, and 0.04<(x+y+z)<0.35.

In the event when the direction of magnetization is orthogonal to the magnetic layer, the magnetic layer may comprise a material having a formula of (TbᵤDy₁₋ᵤ)ₛ(FeₜCo₁₋ₜ)₁₋ₛ according to one embodiment of the present disclosure, wherein u is a number from 0 to 1, s is a number from about 0.05 to about 0.22 and from about 0.25 to about 0.40, and t is a number from 0 to 1.

In the case where the direction of magnetization is at an angle to the magnetic layer, the magnetic layer may comprise a material having a formula of Niₙ(FeₘCo₁₋ₘ)₁₋ₙ, wherein n is a number from 0 to 1, and m is a number from 0 to 1. In another embodiment, the magnetic layer may comprise a material having a formula of (Ni_{q}Gd_{1-q})ₚ(FeᵣCo₁₋ᵣ)₁₋ₚ, wherein p is a number from about 0.18 to about 0.28, q is a number form about 0.3 to about 0.7, and r is a number from 0 to 1.

In accordance with another aspect of the present disclosure, the capacitor includes a first magnetic layer, a first dielectric layer and a second magnetic layer; and both the first magnetic layer and the second magnetic layer are conductive layers. The first magnetic layer is capable of generating a first magnetic field, and has a first coercivity and a first magnetization in a first direction. The second magnetic layer is capable of generating a second magnetic field, and has a second coercivity and a second magnetization in a second direction that is opposite to the first direction, in which the first coercivity is different from the second coercivity. The first dielectric layer is disposed between the first magnetic layer and the second magnetic layer.

According to another embodiment of the present disclosure, the capacitor further comprises a second dielectric layer disposed below the first magnetic layer, and a third magnetic layer disposed below the second dielectric layer, wherein the third magnetic layer is a conductive layer and is capable of generating a third magnetic field and has a third magnetization in a third direction that is identical to the second direction. In one embodiment, the third magnetic layer has a third coercivity that is substantially equal to the second coercivity.

According to one embodiment of the present disclosure, the enhanced dielectric constant of the dielectric layer is in the range of about 10⁷ to about 10⁹.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference to the accompanying drawings as follows:

FIG. 1 is a schematic cross-sectional view of a traditional capacitor in the prior art;

FIG. 2a-FIG. 2c is a schematic cross-sectional view of the capacitor according to one embodiment of the present disclosure;

FIG. 3a-FIG. 3c is a schematic cross-sectional view of the capacitor according to another embodiment of the present disclosure; and

FIG. 4a-FIG. 4c is a schematic cross-sectional view of the capacitor according to another embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

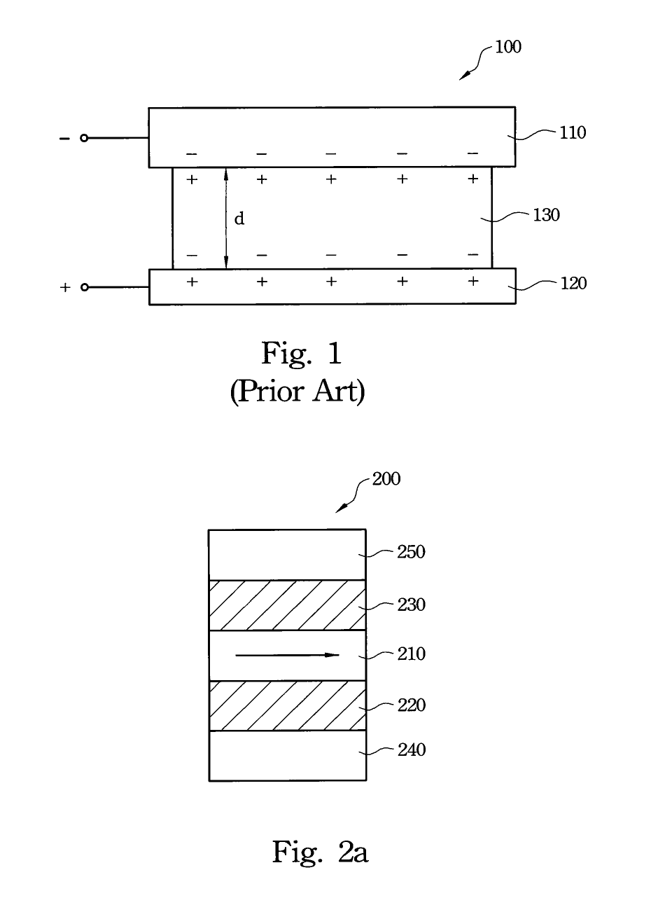

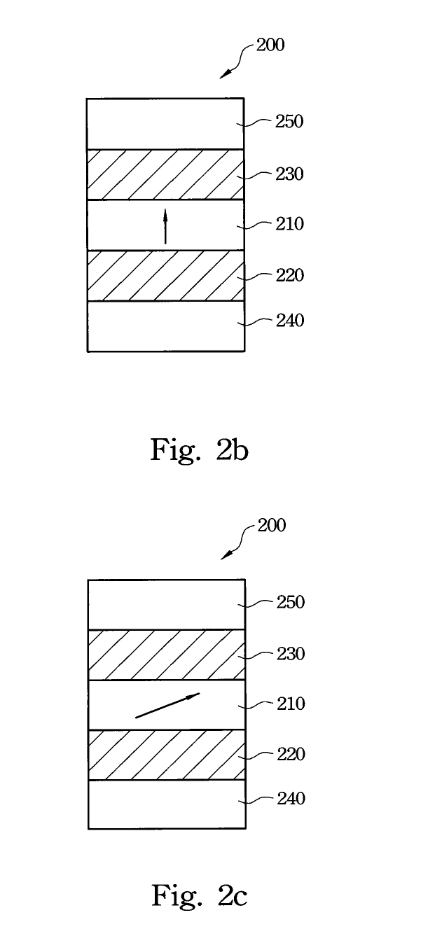

Referring to FIG. 2a, which is a schematic cross-sectional view of a capacitor 200 according to one embodiment of the present disclosure. The capacitor 200 includes a magnetic layer 210, a first dielectric layer 220, a second dielectric layer 230, a first conductive layer 240 and a second conductive layer 250.

The magnetic layer 210 is capable of generating a magnetic field and has a magnetization toward one direction with respective to the magnetic layer 210. The term “magnetization” used herein is defined as the quantity of magnetic moment per unit volume. In one embodiment, the magnitude of the magnetization of the magnetic layer 210 is larger than 100 emu/cm³. For example, the magnetization may range from 100 to 2500 emu/cm³. The direction of the magnetization may be parallel, orthogonal or at an angle with the magnetic layer 210. In one example, the direction of the magnetization is parallel with the magnetic layer 210, as shown in FIG. 2a. In another example, the direction of the magnetization is orthogonal to the magnetic layer 210, as shown in FIG. 2b. In still another example, the direction of the magnetization is at an angle to the magnetic layer 210, as shown in FIG. 2c.

Suitable materials for the magnetic layer 210 include, but is not limited to, (Ni,Fe,Co) family, CoCr(Pt,Ta,Ni,B,Si,O,SiO₂) family, (Pr,Nd,Pm,Sm,Eu,Gd,Tb,Dy,Ho,Er)(Ni,Fe,Co)(Cr,N,Ta,Ti,O,Al,B,Mo) family, (Ni,Fe,Co,Ir,Pt)Mn family, Nd(Ni,Fe,Co)B family, (Ba,Ni,Fe,Co,Mn,Zn,Y,Mg,Zn,Cd)-oxide family, (Pr,Nd,Pm,Sm,Eu,Gd,Tb,Dy,Ho,Er,Al,Ni,Pt,Pd,Si)Co family, and (Pr,Nd,Pm,Sm,Eu,Gd,Tb,Dy,Ho,Er,Al,Ni,Pt,Pd,Si)Fe family.

In the event when the direction of magnetization is parallel with the magnetic layer 210, the magnetic layer 210 may comprise a material having a formula of Ndₓ(Fe_{y}Co_{1-y})₁ₓ according to one embodiment of the present disclosure, wherein x is a number from about 0.10 to about 0.35, and y is a number from 0 to 1. In another embodiment, the magnetic layer 210 may comprise a material having a formula of (NiᵥCo_{w}Cr_{1-v-w})_{1-x-y-z}PtₓTa_{y}B_{z}, wherein v, w, x, y and z are numbers that satisfy the following inequalities: 0≦v<0.2, 0.75<(v+w)≦1, and 0.04<(x+y+z)<0.35.

In the event when the direction of magnetization is orthogonal to the magnetic layer 210, the magnetic layer 210 may comprise a material having a formula of (TbᵤDy₁₋ᵤ)ₛ(FeₜCo₁₋ₜ)₁₋ₛ according to one embodiment of the present disclosure, wherein u is a number from 0 to 1, s is a number from about 0.05 to about 0.22 and from about 0.25 to about 0.40, and t is a number from 0 to 1.

In the case when the direction of magnetization is at an angle to the magnetic layer 210, the magnetic layer 210 may comprise a material having a formula of Niₙ(FeₘCo₁₋ₘ)₁₋ₙ according to one embodiment of the present disclosure, wherein n is a number from 0 to 1, and m is a number from 0 to 1. In another embodiment, the magnetic layer 210 may comprise a material having a formula of (Ni_{q}Gd_{1-q})ₚ(FeᵣCo₁₋ᵣ)₁₋ₚ, wherein p is a number from about 0.18 to about 0.28, and q is a number form about 0.3 to about 0.7, and r is a number form 0 to 1.

The magnetic layer 210 may be formed by any well-known technique that includes, but is not limited to, sputtering, thermo-evaporation, ion-beam assisted evaporation, e-beam evaporation, ion-beam deposition, pulsed laser deposition, and other technologies suitable for forming the magnetic layer 210. For instance, the magnetic layer 210 can be deposited using suitable targets in an argon environment by sputtering.

The thickness of the magnetic layer 210 generally is in the range of about 20 nm to about 1000 nm. More specifically, the thickness of the magnetic layer 210 may range from 20 nm to 200 nm.

The first and the second dielectric layers 220, 230 respectively are disposed below and above the magnetic layer 210. In one embodiment, both the first and the second dielectric layers 220, 230 may contact the magnetic layer 210, as illustrated in FIG. 2a to FIG. 2c. The first and the second dielectric layers 220, 230 may be formed from a material of multiferroics or other conventional dielectric material. The term “multiferroics” herein represents materials that primarily exhibit ferromagnetic, ferroelectric, and ferroelastic properties. In general, multiferroics belong to the group of perovskite-structure metal oxides. In one embodiment, at least one of the first and the second dielectric layers 220, 230 comprises a perovskite-structure metal oxide such as barium strontium titanate (BST), barium titanate (BTO), lead zirconium titanate (PZT), or calcium copper titanate (CCTO). The material of the first dielectric layer 220 may be the same as or different from the material of the second dielectric layer 230.

In some specific examples according to the present disclosure, there exists an optimal magnetization direction of a magnetic layer for each dielectric material for producing a maximum capacitance. For example, the dielectric layers 220, 230 comprising CCTO is suitable for use with a magnetic layer having any magnetization direction, however, a maximum capacitance is observed when the magnetization direction is parallel with the magnetic layer 210. In another example, the dielectric layers 220, 230 comprising BTO is suitable for use with a magnetic layer having any magnetization direction, however, a maximum capacitance is observed when the magnetization direction is orthogonal to the magnetic layer 210. In still another example, the dielectric layers 220, 230 comprising CCTO is suitable for use with a magnetic layer having any magnetization direction, however, a maximum capacitance is observed when the magnetization direction is at an angle to the magnetic layer 210.

The thickness of each of the first and second dielectric layers 220, 230 is typically in the range of about ten to several hundred nanometers. In one example, the thickness of the dielectric layer 220 is about 10-100 nm.

The first conductive layer 240 is disposed below the first dielectric layer 220, and the second conductive layer 250 is disposed above the second dielectric layer 230, wherein both the first and the second conductive layers 240, 250 are non-magnetic. In one embodiment, at least one of the first and second conductive layers 240, 250 comprises at least one metal selected from the group consisting of Ag, Cu, Pt, Cr, Au, Ta, Ti and Al. The thickness of each of the first and second conductive layers 240, 250 may be in the range from about 3 nm to about 10 μm, for example. Thin film processes such as various physical depositions or thick-film processes such as screen-printing can be utilized to form the first and the second conductive layers 240, 250, respectively, depending on the desired thickness. In one embodiment, the first conductive layer 240 and the second conductive layer 250 may be used as electrode pads for charging or discharging.

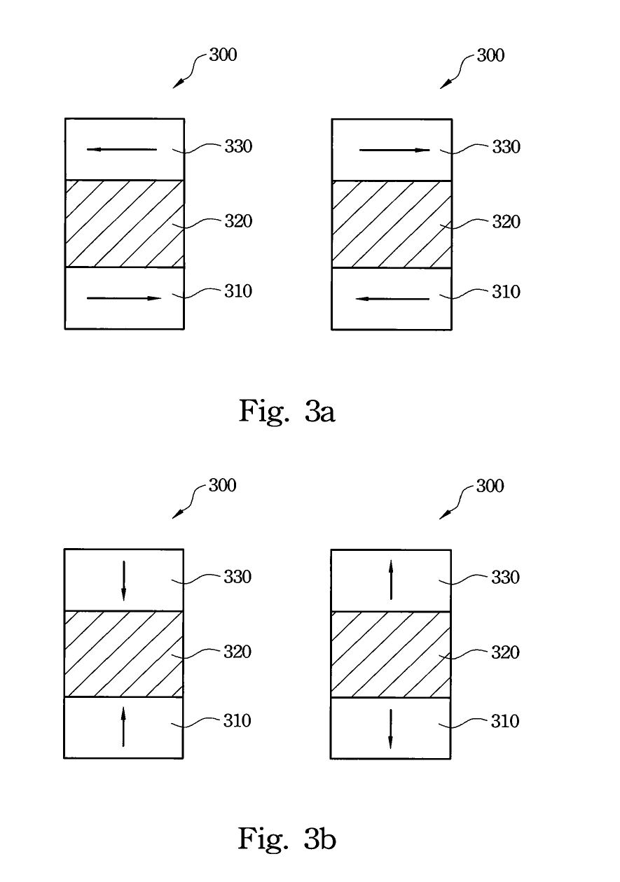

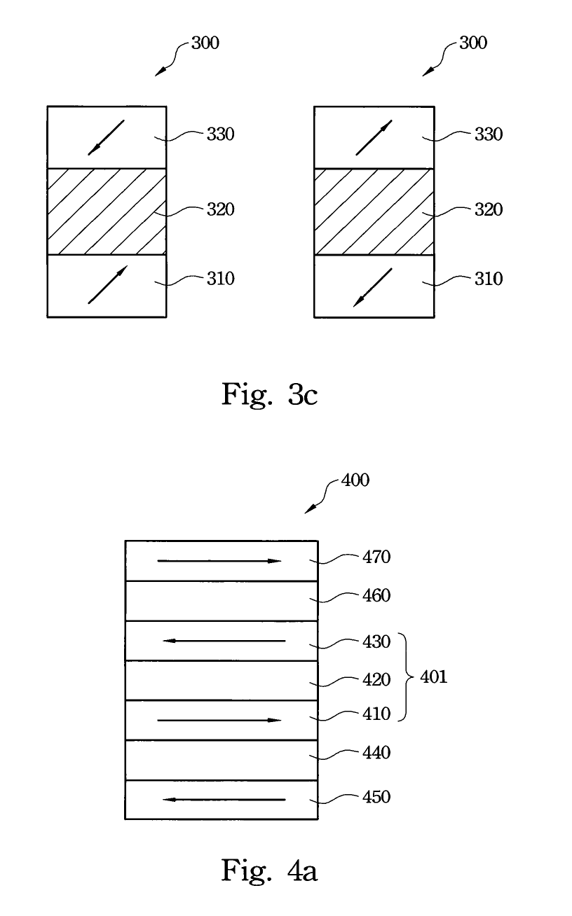

Referring to FIG. 3a, which is a schematic cross-sectional view of a capacitor 300 according to another embodiment of the present disclosure. The capacitor 300 includes a first magnetic layer 310, a dielectric layer 320, and a second magnetic layer 330. Both the first magnetic layer 310 and the second magnetic layer 330 are conductive layers, and the dielectric layer 320 is sandwiched between the first magnetic layer 310 and the second magnetic layer 330.

The first and second magnetic layers 310, 330 are respectively capable of generating a first magnetic field and a second magnetic field, and respectively having a first magnetization in a first direction and a second magnetization in a second direction. Furthermore, the first direction of the first magnetization is opposite to the second direction of the second magnetization. However, both the directions of the first and second magnetizations are not limited to any specific direction. For instance, both the directions of the first and second magnetizations may be parallel or orthogonal to the first magnetic layer 310; alternatively both the directions of the first and second magnetizations may be at an angle to the first magnetic layer 310.

In one embodiment, the first direction of the first magnetization is opposite to the second direction of the second magnetization, and both the first and second directions are parallel to the first magnetic layer 310, as shown in FIG. 3a. According to one embodiment of the present disclosure, at least one of the first and second magnetic layers 310, 330 may comprise a material having a formula of Ndₓ(Fe_{y}Co_{1-y})₁₋ₓ wherein x is a number from about 0.10 to about 0.35, and y is a number from 0 to 1. In another embodiment, at least one of the first and second magnetic layers 310, 330 may comprise a material having a formula of (NiᵥCo_{w}Cr_{1-v-w})_{1-x-y-z}PtₓTa_{y}B_{z}, wherein v, w, x, y and z are numbers that satisfy the following inequalities: 0≦v<0.2, 0.75<(v+w)≧1, and 0.04<(x+y+z)<0.35.

In one embodiment, as shown in FIG. 3b, the first direction of the first magnetization is opposite to the second direction of the second magnetization, and both the first and second directions are orthogonal to the first magnetic layer 310. In this embodiment, at least one of the first and second magnetic layers 310, 330 may comprise a material having a formula of (TbᵤDy₁₋ᵤ)ₛ(FeₜCo₁₋ₜ)₁₋ₛ wherein u is a number from 0 to 1, s is a number from about 0.05 to about 0.22 and from about 0.25 to about 0.40, and t is a number from 0 to 1.

In one embodiment, as shown in FIG. 3c, the first direction of the first magnetization is opposite to the second direction of the second magnetization, and both the first and second directions are at an angle to the first magnetic layer 310. According to one embodiment of the present disclosure, at least one of the first and second magnetic layers 310, 330 may comprise a material having a formula of Niₙ(FeₘCo₁₋ₘ)₁₋ₙ, wherein n is a number from 0 to 1, and m is a number from 0 to 1. In another embodiment, at least one of the first and second magnetic layers 310, 330 may comprise a material having a formula of (Ni_{q}Gd_{1-q})ₚ(FeᵣCo₁₋ᵣ)₁₋ₚ, wherein p is a number from about 0.18 to about 0.28, q is a number from about 0.3 to about 0.7, and r is a number from 0 to 1.

In one embodiment, at least one of the first and second magnetization is larger than 100 emu/cm³. For example, the first magnetization and/or the second magnetization may be in the range from about 100 to about 2500 emu/cm³.

There is no particular limitation on the thickness of each of the first and the second magnetic layer 310, 330, however, it is generally in the range of about 20 nm to about 1000 nm. More specifically, the thickness of each of the magnetic layer 310, 330 may range from 20 nm to 200 nm.

The first and second magnetic layers 310, 330 respectively have a first and second coercivity, and the first coercivity is different from the second coercivity. The term “coercivity” (also referred to “coercive field”) herein represents the intensity of an applied magnetic field required to reduce the magnetization of a material to zero after the magnetization of the material has been driven to saturation. In some embodiments, the first coercivity differs from the second coercivity by about 200 Oe to about 7,000 Oe.

The dielectric layer 320 is disposed between the first magnetic layer 310 and the second magnetic layer 330. In one embodiment, the dielectric layer 320 directly contacts the first magnetic layer 310 and the second magnetic layer 330, as shown in FIG. 3a to FIG. 3c. In another embodiment, the dielectric layer 320 comprises a perovskite-structure metal oxide such as barium strontium titanate (BST), barium titanate (BTO), lead zirconium titanate (PZT), or calcium copper titanate (CCTO). There is no particular limitation on the thickness of the dielectric layer 320, however, it is typically in the range from about ten to several hundred nanometers. More specifically, the thickness of the dielectric layer 320 is about 10-100 nm.

According to some specific examples of the present disclosure, there exists an optimal magnetization direction of a magnetic layer for each dielectric material for producing a maximum capacitance. For example, the dielectric layer 320 comprising CCTO is suitable for use with a magnetic layer having any magnetization direction, however, a maximum capacitance is observed when each of the first and second magnetization directions is respectively parallel with the magnetic layers 310, 330. In another example, the dielectric layer 320 comprising BTO is suitable for use with a magnetic layer having any magnetization direction, however, a maximum capacitance is observed when each of the first and second magnetization directions is respectively orthogonal to the magnetic layers 310, 330. In still another example, the dielectric layer 320 comprising CCTO is suitable for use with a magnetic layer having any magnetization direction, however, a maximum capacitance is observed when each of the first and second magnetization directions is respectively at an angle to the magnetic layers 310, 330.

The magnetic layer is capable of generating a magnetic field, and the magnetic field may interact with the dielectric material approximating the interface between the magnetic layer and the dielectric layer. The magnetic field may possibly induce more electric dipoles in the dielectric layer approximating the interface between the magnetic layer and the dielectric layer. As a result, the effective K-value of the dielectric layer may be enhanced for at least 10 folds, for example, 10²-10³ folds, as compared to the conventional capacitor without magnetic layer. In some specific embodiments, the enhanced dielectric constant may be increased to the range of 10⁷ to 10⁹. Furthermore, the required magnetic layer can easily be formed by appropriate thin film process. The capacitors can be manufactured to be very compact in size, and therefore achieving a higher energy density.

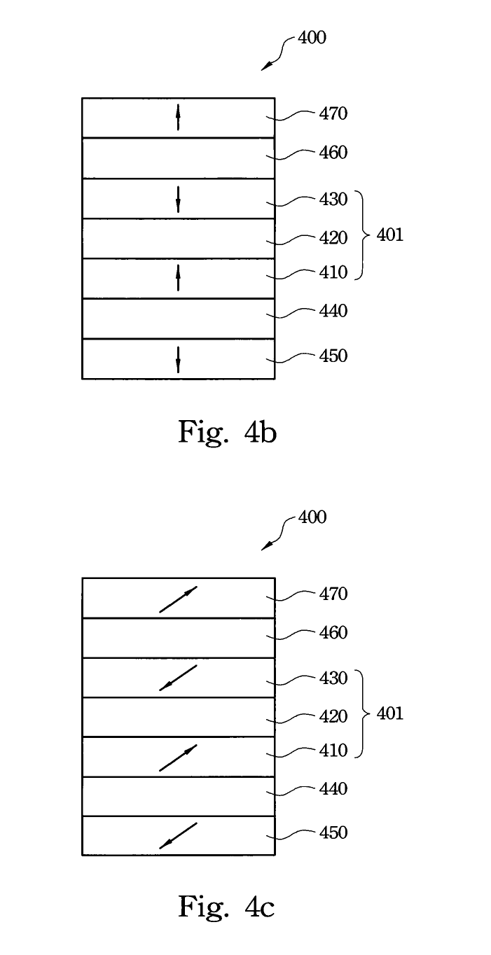

Referring to FIG. 4a, which is a schematic cross-sectional view of a capacitor 400 according to another embodiment of the present disclosure. The capacitor 400 includes a core structure 401 comprising a first magnetic layer 410, a first dielectric layer 420 and a second magnetic layer 430; a second dielectric layer 440; a third magnetic layer 450; a third dielectric layer 460 and a fourth magnetic layer 470. The core structure 401 is identical to the capacitor 300 illustrated in FIG. 3a to FIG. 3c, and the first direction of the first magnetization is opposite to the second direction of the second magnetization, as described hereinbefore.

The second dielectric layer 440 is disposed below the first magnetic layer 410, and the third magnetic layer 450 is disposed below the second dielectric layer 440. The third dielectric layer 460 is disposed above the second magnetic layer 430, and the fourth magnetic layer 470 is disposed above the third dielectric layer 460.

The third and the fourth magnetic layers 450, 470 may respectively generate a third magnetic field and a fourth magnetic field, and may respectively have a third magnetization in a third direction and a fourth magnetization in a fourth direction. In one embodiment, the third direction of the third magnetization is identical to the second direction of the second magnetization, and the fourth direction is identical to the first direction of the first magnetization.

In one embodiment, all of the first, second, third, and fourth direction are parallel to the first magnetic layer 310, as shown in FIG. 4a. In another embodiment, as shown in FIG. 4b, all of the first, second, third, and fourth direction are orthogonal to the first magnetic layer 310. In still another embodiment, as shown in FIG. 4c, all of the first, second, third, and fourth direction are at an angle to the first magnetic layer 310.

The material of the third magnetic layer 450 may be the same as or different from that of the second magnetic layer 430. Moreover, the material of the fourth magnetic layer 470 may be the same as or different from that of the first magnetic layer 410. In one embodiment, both the second and the third magnetic layers 430, 450 are made of or made from the same materials. In another embodiment, both the first and the fourth magnetic layers 410, 470 are made of or made from the same materials.

The first magnetic layer 410 has a first coercivity and the second magnetic layer 430 has a second coercivity that is different from the first coercivity. Furthermore, the third and the fourth magnetic layers 450, 470 respectively have a third and fourth coercivity. In one embodiment, the third coercivity is substantially equal to the second coercivity. In another embodiment, the fourth coercivity is substantially equal to the first coercivity.

### Example 1

### Fabricating a Capacitor Characterized in having One Magnetic Layer for Generating a Magnetic Field that is Parallel with the Magnetic Layer

A layer of aluminum (Al) about 50 nm in thickness was deposited on a ceramic substrate using an Al target in an argon (Ar) environment by sputtering. During the Al sputtering process, a DC source of 3 Kw was used and the Ar flow rate was 30 sccm. Next, a 25 nm layer of CaCu₃Ti₄O₁₂ (CCTO) was deposited on the Al layer using a CCTO target in an argon (Ar) environment by sputtering. During the CCTO sputtering process, a RF source of 1 Kw was used and the Ar flow rate was also 30 sccm. And then, a layer of Nd—Fe—Co alloy about 50 nm in thickness was deposited on the CCTO layer in an argon (Ar) environment by sputtering. In this example, the Nd—Fe—Co layer has a formula of Nd_{0.25}(Fe_{0.80}Co_{0.20})_{0.75}. After the Nd—Fe—Co layer was formed, a second layer of CCTO about 25 nm in thickness was deposited on Nd—Fe—Co layer. And then, a second layer of Al about 50 nm in thickness was deposited on the second CCTO layer.

After the above-mentioned layers were formed, an external magnetic field parallel with the Nd—Fe—Co layer was applied to initialize the magnetization of the magnetic layer. The applied magnetic field was larger than 500 Oe to overcome the coercivity of the Nd—Fe—Co layer. After removing the external magnetic field, the magnetization of the Nd—Fe—Co layer remained parallel with the layer surface, and generated a magnetic field that is parallel with the Nd—Fe—Co layer. In this example, the Nd—Fe—Co layer had a magnetization of about 2000 emu/cm³ and the dielectric constant of the dielectric layer (CCTO) was increased up to about 10⁹.

### Example 2

### Fabricating a Capacitor Characterized in having One Magnetic Layer for Generating a Magnetic Field that is Orthogonal to the Magnetic Layer

A layer of Al was prepared in accordance with the procedures described in Example 1. A 50 nm layer of barium titanate (BTO) was deposited on the Al layer using a BTO target in an argon (Ar) environment by sputtering. Next, a layer of (Tb_{0.5}Dy_{0.5})_{0.21}(Fe_{0.80}Co_{0.20})_{0.79} was deposited on the BTO layer in an argon environment by a sputtering process. In this example, the Tb—Dy—Fe—Co layer had a thickness of about 50 nm. After the Tb—Dy—Fe—Co layer was formed, a second layer of BTO about 25 nm in thickness was deposited on Tb—Dy—Fe—Co layer, followed by the deposition of a second layer of Al about 50 nm in thickness on the second BTO layer.

After the above-mentioned structure was completed, an external magnetic field orthogonal to the Tb—Dy—Fe—Co layer was applied to initialize the magnetization of the magnetic layer. The applied magnetic field was larger than 10,000 Oe to overcome the coercivity of the Tb—Dy—Fe—Co layer. After removing the external magnetic field, the Tb—Dy—Fe—Co layer had a magnetization in the direction perpendicular to the layer surface and was capable of generating a magnetic field orthogonal to the Tb—Dy—Fe—Co layer. In this example, the Tb—Dy—Fe—Co layer had a magnetization of about 200 emu/cm³ and the dielectric constant of the dielectric layer (BTO) was increased up to about 10⁷.

### Example 3

### Fabricating a Capacitor Characterized in having One Magnetic Layer for Generating a Magnetic Field that is at an Angle to the Magnetic Layer

A layer of Al and a layer of CCTO were deposited in sequence in accordance with the procedures described in Example 1. Next, a 50 nm layer of Ni—Fe—Co alloy with a formula of Ni_{0.20}(Fe_{0.80}Co_{0.20})_{0.80} was deposited on the CCTO layer in an argon environment by sputtering. And then, a second layer of CCTO and a second layer of Al were deposited in sequence on the Ni—Fe—Co layer.

Next, an external magnetic field was applied to initialize the magnetization of the magnetic layer. The applied magnetic field was larger than 500 Oe and in a direction at an angle of 45 degree to the plane of the Ni—Fe—Co layer. After removing the external magnetic field, the Ni—Fe—Co layer had a magnetization in the direction at an angle of 45 degree to the plane of the Ni—Fe—Co layer. In this example, the Ni—Fe—Co layer had a magnetization of about 1500 emu/cm³ and the enhanced dielectric constant of the dielectric layer was increased up to about 10⁹.

### Example 4

### Fabricating a Capacitor Characterized in having Two Magnetic Layers for Generating a Magnetic Field that is Parallel with the Magnetic Layer

A 50 nm layer of Nd_{0.25}(Fe_{0.80}Co_{0.20})_{0.75} was deposited on a ceramic substrate, followed by the deposition of a 50 nm layer of CCTO on the Nd—Fe—Co layer in accordance with the procedures described in Example 1. Next, a layer of Co_{0.73}Cr_{0.17}Pt_{0.06}Ta_{0.04} about 50 nm in thickness was deposited on the layer of CCTO using a prepared target (Co_{0.73}Cr_{0.17}Pt_{0.06}Ta_{0.04}) in an argon (Ar) environment by sputtering. In this example, the coercivity of the Nd—Fe—Co layer is about 200 Oe, and the coercivity of the Co—Cr—Pt—Ta layer is about 1,000 Oe, which is larger than the coercivity of the Nd—Fe—Co layer.

Next, an external magnetic field of 2,000 Oe was applied in a first direction parallel with the Nd—Fe—Co layer to initialize the magnetization of the Nd—Fe—Co layer. After removing the magnetic field, the Nd—Fe—Co layer had a magnetization in the first direction, and the Co—Cr—Pt—Ta layer also had a magnetization in the same direction. Another external magnetic field of 500 Oe was subsequently applied to the opposite direction of the first direction to change the magnetization of the Nd—Fe—Co layer. Since the external magnetic field of 500 Oe was smaller than the coercivity of the Co—Cr—Pt—Ta layer, hence the magnetization of the Co—Cr—Pt—Ta layer remained unchanged, however, the magnetization of the Nd—Fe—Co layer was changed by the magnetic field of 500 Oe for the coercivity of Nd—Fe—Co layer is smaller than 500 Oe. Therefore, the magnetization of the Nd—Fe—Co layer was changed to the opposite direction of the first direction. Thus, the Nd—Fe—Co layer had a magnetization in the direction opposite to the direction of the magnetization of the Co—Cr—Pt—Ta layer. In this example, the dielectric constant of the CCTO layer was enhanced and increased up to about 10⁹.

### Example 5

### Fabricating a Capacitor Characterized in having Two Magnetic Layers for Generating a Magnetic Field that is Orthogonal to the Magnetic Layer

A layer of (Tb_{0.5}Dy_{0.5})_{0.21}(Fe_{0.80}Co_{0.20})_{0.79} about 50 nm in thickness was deposited on a ceramic substrate, followed by the deposition of a 50 nm layer of BTO on the layer of (Tb_{0.5}Dy_{0.5})_{0.21}(Fe_{0.80}Co_{0.20})_{0.79}. Next, a layer of (Tb_{0.5}Dy_{0.5})_{0.18}(Fe_{0.80}Co_{0.20})_{0.82} about 50 nm in thickness was deposited on the BTO layer. In this example, the coercivity of the (Tb_{0.5}Dy_{0.5})_{0.21}(Fe_{0.80}CO_{0.20})_{0.79} layer is about 10,000 Oe, and the coercivity of the (Tb_{0.5}Dy_{0.5})_{0.18}(Fe_{0.80}Co_{0.20})_{0.82} layer is about 3,000 Oe.

Next, an external magnetic field of 15,000 Oe was applied to a second direction, which is orthogonal to the (Tb_{0.5}Dy_{0.5})_{0.21}(Fe_{0.08}Co_{0.20})_{0.79} layer, to initialize the magnetization of the (Tb_{0.5}Dy_{0.5})_{0.21}(Fe_{0.80}Co_{0.20})_{0.79} layer. After removing the magnetic field, the (Tb_{0.5}Dy_{0.5})_{0.21}(Fe_{0.80}Co_{0.20})_{0.79} layer had a magnetization in the second direction, and the (Tb_{0.5}Dy_{0.5})_{0.18}(Fe_{0.80}Co_{0.20})_{0.82} layer also had a magnetization in the same direction. Next, an external magnetic field of 5,000 Oe, which is smaller than the coercivity of the (Tb_{0.5}Dy_{0.5})_{0.21}(Fe_{0.80}Co_{0.20})_{0.79} layer, was applied to the direction that is opposite to the second direction. After removing the magnetic field, the magnetization of the (Tb_{0.5}Dy_{0.5})_{0.18}(Fe_{0.80}Co_{0.20})_{0.82} layer was changed to be the opposite direction of the second direction. Thus, the (Tb_{0.5}Dy_{0.5})_{0.18}(Fe_{0.80}Co_{0.20})_{0.82} layer had a magnetization in the direction opposite to the direction of the magnetization of the (Tb_{0.5}Dy_{0.5})_{0.21}(Fe_{0.80}Co_{0.20})_{0.79} layer. In this example, the dielectric constant of the BTO layer was enhanced and increased up to about 10⁷.

### Example 6

### Fabricating a Capacitor Characterized in having Two Magnetic Layers for Generating a Magnetic Field that is at an Angle to the Magnetic Layer

A layer of Ni_{0.2}(Fe_{0.80}Co_{0.20})_{0.8} was deposited on a ceramic substrate, followed by the deposition of a CCTO layer on the Ni—Fe—Co layer. And then, a layer of (Ni_{0.5}Gd_{0.5})_{0.2}(Fe_{0.8}Co_{0.2})_{0.8} was deposited on the CCTO layer. All of the Ni—Fe—Co layer, the CCTO layer and the Ni—Gd—Fe—Co layer are about 50 nm in thickness. In this example, the coercivity of the Ni—Fe—Co layer is about 100 Oe, and the coercivity of the Ni—Gd—Fe—Co layer is about 300 Oe.

An external magnetic field of 500 Oe was applied in a third direction at an angle of 45 degree to the plane of the Ni—Gd—Fe—Co layer to initialize the magnetization of the Ni—Gd—Fe—Co layer. After removing the magnetic field, both of the magnetizations of the Ni—Gd—Fe—Co layer and the Ni—Fe—Co layer are in the third direction. Another external magnetic field of 200 Oe was subsequently applied to the opposite direction of the third direction to change the magnetization of the Ni—Fe—Co layer. Consequently, the Ni—Fe—Co layer had a magnetization in the direction opposite to the direction of the magnetization of the Ni—Gd—Fe—Co layer. In this example, the dielectric constant of the CCTO layer was enhanced and increased up to about 10⁹.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A capacitor, comprising:
a magnetic layer capable of generating a magnetic field and having a magnetization;
a first dielectric layer disposed below the magnetic layer;
a second dielectric layer disposed above the magnetic layer;
a first conductive layer disposed below the first dielectric layer; and
a second conductive layer disposed above the second dielectric layer;
wherein both the first and the second conductive layers are non-magnetic.

2. The capacitor according to claim 1, wherein the magnetization is larger than 100 emu/cm³.

3. The capacitor according to claim 1, wherein the magnetic layer has a thickness of about 20 nm to about 1000 nm.

4. The capacitor according to claim 1, wherein the magnetization of the magnetic layer has a direction that is parallel with the magnetic layer.

5. The capacitor according to claim 4, wherein the magnetic layer comprises a material having a formula of Ndₓ(Fe_{y}Co_{1-y})₁₋ₓ, wherein x is a number from about 0.10 to about 0.35, and y is a number from 0 to 1.

6. The capacitor according to claim 4, wherein the magnetic layer comprises a material having a formula of (NiᵥCo_{w}Cr_{1-v-w})_{1-x-y-z}PtₓTa_{y}B_{z}, wherein v, w, x, y and z are numbers that satisfy the following inequalities: 0≦v<0.2, 0.75<(v+w)≦1, and 0.04<(x+y+z)<0.35.

7. The capacitor according to claim 1, wherein the magnetization of the magnetic layer has a direction that is orthogonal to the magnetic layer.

8. The capacitor according to claim 7, wherein the magnetic layer comprises a material having a formula of (TbᵤDy₁₋ᵤ)ₛ(FeₜCo₁₋ₜ)₁₋ₛ, wherein u is a number from 0 to 1, s is a number from about 0.05 to about 0.22 and from about 0.25 to about 0.40, and t is a number from 0 to 1.

9. The capacitor according to claim 1, wherein the magnetization of the magnetic layer has a direction that is at an angle to the magnetic layer.

10. The capacitor according to claim 9, wherein the magnetic layer comprises a material having a formula of Niₙ(FeₘCo₁₋ₘ)₁₋ₙ, wherein n is a number from 0 to 1, and m is a number from 0 to 1.

11. The capacitor according to claim 9, wherein the magnetic layer comprises a material having a formula of (Ni_{q}Gd_{1-q})ₚ(FeᵣCo₁₋ᵣ)₁₋ₚ, wherein p is a number from about 0.18 to about 0.28, q is a number from about 0.3 to about 0.7, and r is a number from 0 to 1.

12. The capacitor according to claim 1, wherein at least one of the first and the second dielectric layer comprises at least one material selected from the group consisting of barium strontium titanate (BST), barium titanate (BTO), lead zirconium titanate (PZT), and calcium copper titanate (CCTO).

13. The capacitor according to claim 1, wherein at least one of the first and the second conductive layer comprises at least one metal selected from the group consisting of Ag, Cu, Pt, Cr, Au, Ta, Ti and Al.

14. A capacitor, comprising:
a first magnetic layer capable of generating a first magnetic field, wherein the first magnetic layer has a first coercivity and a first magnetization in a first direction;
a first dielectric layer disposed above the first magnetic layer; and
a second magnetic layer disposed above the first dielectric layer, wherein the second magnetic layer is capable of generating a second magnetic field, and has a second coercivity and a second magnetization in a second direction which is opposite to the first direction;
wherein the first coercivity is different from the second coercivity and both the first magnetic layer and the second magnetic layer are conductive layers.

15. The capacitor according to claim 14, further comprising:
a second dielectric layer disposed below the first magnetic layer; and
a third magnetic layer disposed below the second dielectric layer, wherein the third magnetic layer is a conductive layer and is capable of generating a third magnetic field and has a third magnetization in a third direction that is identical to the second direction.

16. The capacitor according to claim 15, wherein the third magnetic layer has a third coercivity that is substantially equal to the second coercivity.

17. The capacitor according to claim 15, further comprising:
a third dielectric layer disposed above the second magnetic layer; and
a fourth magnetic layer disposed above the third dielectric layer, wherein the fourth magnetic layer is conductive and capable of generating a fourth magnetic field and has a fourth magnetization in a fourth direction which is identical to the first direction.

18. The capacitor according to claim 17, wherein the fourth magnetic layer has a fourth coercivity that is substantially equal to the first coercivity.

19. The capacitor according to claim 14, wherein the dielectric constant of the first dielectric layer is enhanced by the first and the second magnetic field for at least 10 folds.

20.The capacitor according to claim 14, wherein the first coercivity and the second coercivity differ by about 200 Oe to about 7,000 Oe.

21.The capacitor according to claim 14, wherein at least one of the first and the second magnetizations is larger than 100 emu/cm³.

22.The capacitor according to claim 14, wherein the first direction of the first magnetization is parallel with the first magnetic layer.

23. The capacitor according to claim 22, wherein at least one of the first and the second magnetic layers comprises a material having a formula of Ndₓ(Fe_{y}Co_{1-y})₁₋ₓ, wherein x is a number from about 0.10 to about 0.35, and y is a number from 0 to 1.

24. The capacitor according to claim 22, wherein at least one of the first and the second magnetic layers comprises a material having a formula of (NiᵥCo_{w}Cr_{1-v-w})_{1-x-y-z}PtₓTa_{y}B_{z}, wherein v, w, x, y and z are numbers that satisfy the following inequalities: 0≦v<0.2, 0.75<(v+w)≦1, and 0.04<(x+y+z)<0.35.

25. The capacitor according to claim 14, wherein the first direction of the first magnetization is orthogonal to the first magnetic layer.

26.The capacitor according to claim 25, wherein at least one of the first and the second magnetic layers comprises a material having a formula of (TbᵤDy₁₋ᵤ)ₛ(FeₜCo₁₋ₜ)₁₋ₛ, wherein u is a number from 0 to 1, s is a number from about 0.05 to about 0.22 and from about 0.25 to about 0.40, and t is a number from 0 to 1.

27. The capacitor according to claim 14, wherein the first direction of the first magnetization is at an angle to the first magnetic layer.

28. The capacitor according to claim 27, wherein at least one of the first and the second magnetic layers comprises a material having a formula of Niₙ(FeₘCo₁₋ₘ)₁₋ₙ, wherein n is a number from 0 to 1, and m is a number from 0 to 1.

29. The capacitor according to claim 27, wherein at least one of the first and the second magnetic layers comprises a material having a formula of (Ni_{q}Gd_{1-q})ₚ(FeᵣCo₁₋ᵣ)₁ₚ, wherein p is a number from about 0.18 to about 0.28, q is a number from about 0.3 to about 0.7, and r is a number from 0 to 1.

30. The capacitor according to claim 14, wherein where at least one of the first and the second magnetic layer has a thickness of about 20 nm to about 1000 nm.

31. The capacitor according to claim 14, wherein the first dielectric layer comprises at least one material selected form the group consisting of barium strontium titanate (BST), barium titanate (BTO), lead zirconium titanate (PZT), and calcium copper titanate (CCTO).
